(19) United States
(12) Patent Application Publication
(10) Pub. No.: US 2024/0014417 A1
(43) Pub. Date: Jan. 11, 2024

(54) ANODE CIRCUIT

(71) Applicant: CELLCENTRIC GMBH & CO. KG, Kirchheim/Teck-Nabern (DE)

(72) Inventors: Joachim KARNAHL, Kirchheim/Teck-Nabern (DE); Sven PEGEL, Kirchheim/Teck-Nabern (DE); Daniel KRAMER, Kirchheim/Teck-Nabern (DE)

(21) Appl. No.: 18/254,542

(22) PCT Filed: Nov. 25, 2021
(86) PCT No.: PCT/EP2021/083019

§ 371 Date: May 25, 2023

(30) Foreign Application Priority Data
Nov. 26, 2020 (DE) 10 2020 007 228.3

(51) Int. Cl. H01M 8/04089; F04F 5/46; F04F 5/16

(52) U.S. Cl. CPC H01M 8/04097; F04F 5/466; F04F 5/16; H01M 2250/20; B60L 50/70

(57) ABSTRACT

The invention relates to an anode circuit (8) for a fuel cell (3) having at least one gas jet pump (6) for recirculating anode exhaust gas, which has at least one nozzle (18) through which the fuel gas (H 2) may flow as a fuel gas flow, and which has a fuel gas line (14), a recirculation line (7), and an outflow line (15). The anode circuit according to the invention is characterized in that a plurality of nozzles (18) with different geometries are arranged in a nozzle body (16), which is movable relative to the fuel gas line (14) in such a manner that in each case one of the nozzles (18) is selectively usable.

The invention relates to an anode circuit for a fuel cell having a plurality of gas jet pumps of a type further defined in the preamble of claim 1.

The recirculation of anode exhaust gas in fuel cell systems is generally known and common practice. Hereto, the anode exhaust gas is returned to the anode inlet by means of a recirculation line, usually via a water separator, and is fed back to it mixed with fresh fuel gas, thus it is possible to always dose the active surface of the anode with an excess of hydrogen without significant hydrogen losses. For recirculation of the anode exhaust gas, recirculation fans and, alternatively or additionally, gas jet pumps are known.

Here it is the case that the efficiency of gas jet pumps typically varies with the dosed volume flow, the so-called fuel gas flow. Ideally, the geometry of the gas jet pump is configured to match the respective fuel gas flow to achieve an ideal recirculation also for different volume flows of dosed hydrogen. In order to implement this in practice, movable nozzle needles are often used, which are located inside a nozzle of the gas jet pump and release different flow cross sections in the nozzle by moving in the direction of flow and against the direction of flow. This is quite complex and quite susceptible to freezing as the movable parts are located directly in the nozzle.

Furthermore, it is also known from general practice to arrange multiple gas jet pumps in parallel. They may then be interconnected via sophisticated valves and lines such that either the one or the other or a plurality of the gas jet pumps may be used together. This is also quite complex and expensive due to the large number of lines and valves.

KR 2012 0057996 A adopts such a configuration including a plurality of nozzle bodies in a single gas jet pump, and forms a device which enhances the described structure by using a rotary valve. The rotary valve allows to pivot a rotatable valve body such that one or more of the nozzles may be selectively used. The principle is also basically known from the field of cooling circuits and is described accordingly in JP 2005-155571 A1.

It is an objective of the present invention to further develop an anode circuit according to the preamble of claim 1 thus that it may be optimized regarding the recirculation efficiency depending on the situation with an efficient and compact configuration.

According to the invention, this task is solved by an anode circuit comprising the features of claim 1. Advantageous embodiments and further developments result from the subclaims which are dependent thereon.

Thus, the anode circuit for a fuel cell according to the invention comprises at least one gas jet pump for recirculating of anode exhaust gas similar to the configuration in prior art described above. Here, as there, the fuel gas serves as a fuel gas flow which flows through the nozzle of the at least one gas jet pump and takes in anode exhaust gas from a recirculation line. The resulting mixture then flows out of the gas jet pump via an outflow line and typically to the anode space of the fuel cell, particularly a stack or stacks of individual cells.

According to the invention, a plurality of nozzles having different geometries are arranged in one nozzle body. This is movable relative to the fuel gas line in such a way that one of the nozzles may be selectively used, respectively. Here, in contrast to the above-mentioned prior art, not all of the nozzles are provided and are flowed to individually or in parallel, as required, but the individual nozzles in a shared nozzle body are moved into the region of the fuel gas line by an actuator, for example by a linear movement or by pivoting them into the region. Depending on the current fuel gas flow, which depends on the current hydrogen dosing in the fuel cell, the appropriate nozzle may be selected from the shared nozzle body and brought into the use position.

The nozzle body itself may be strip-shaped, for example, and then has to be displaced by means of a linear acting actuator transversely to the fuel gas line, which, according to an advantageous further development, is ideally aligned with the outflow line.

Regarding the required installation space, it is particularly efficient and favorable, when the nozzle body is configured to be rotatable, namely with an axis of rotation arranged off-center to the fuel gas line. It may then be implemented in a very space-saving manner and may be rotated into the desired position by twisting it, if required, which may be compared to a drum of a revolver, so that the nozzle currently required is aligned with the fuel gas line and, in particular, the outflow line and then, when flowing through the gas jet pump, an ideal flow may be achieved for the intake of the anode exhaust gas from the recirculation line, typically with flow velocities of more than Mach 1, suitable for the respective volume flow of the dosed hydrogen.

The center axes of the individual nozzles are ideally arranged on a constant radius around the axis of rotation of the nozzle body. For example, depending on the diameter of the nozzle body, four to six individual nozzles may be provided and rotated into the fuel gas line of the gas jet pump, if required.

Ideally, the nozzle body tapers in the flow direction of the fuel gas flow, thus the flow resistance for the exhaust gas stream which has been taken in is reduced accordingly, and it is directed into the gas jet pump using an ideal flow geometry.

The recirculation line may end in the gas jet pump in an arbitrary way. For example, the recirculated gas stream and the fuel gas stream may enter the gas jet pump in parallel. In general, an anti-parallel alignment with a deflection within the gas jet pump is also conceivable. However, it may be in particular advantageous to arrange the recirculation line at an angle to the fuel gas line and/or the outflow line, in particular, perpendicular to the alignment of these two lines.

Further advantageous embodiments of the anode circuit according to the invention and the gas jet pump thereof, also result from the exemplary embodiment, which is described in more detail

Here shows:

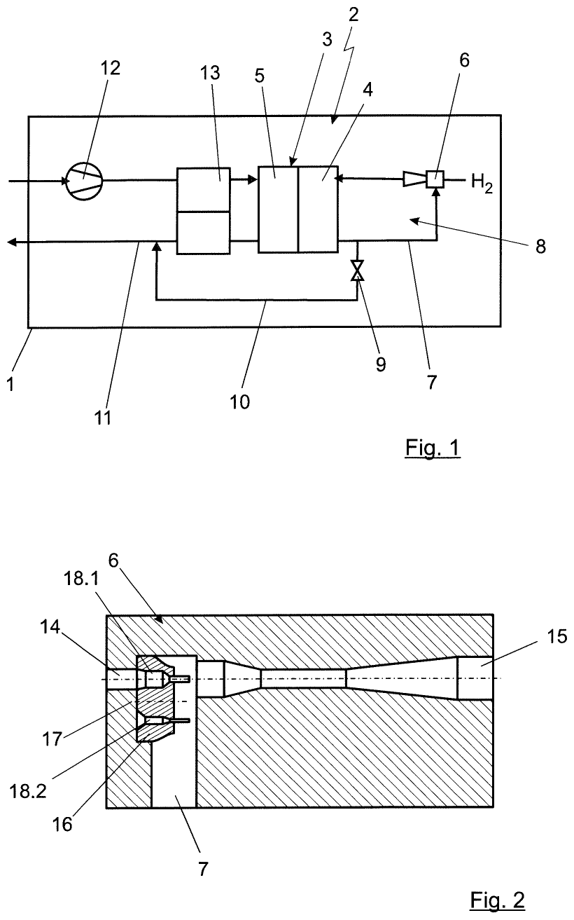

FIG. 1 a fuel cell system shown in principle in an at least partially electrically driven vehicle;

FIG. 2 a gas jet pump according to the invention in a sectional view in a first operating condition;

FIG. 3 the gas jet pump according to FIG. 2 in a second operating state; and

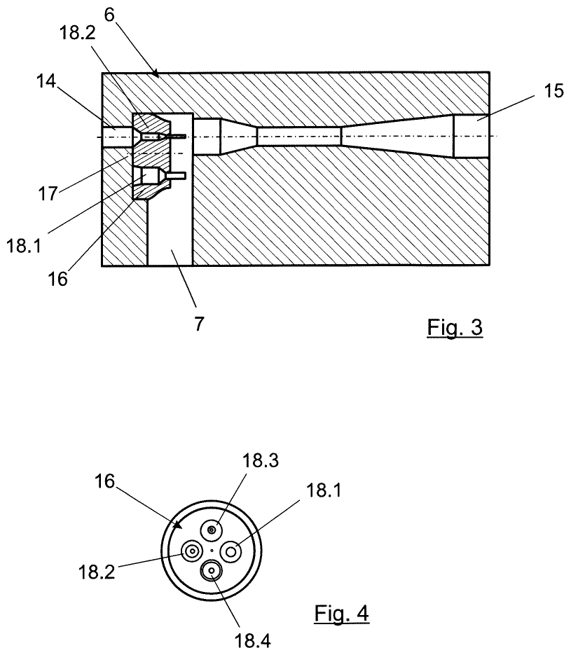

FIG. 4 a top view of the nozzle body used in the gas jet pump according to FIGS. 2 and 3.

The illustration in FIG. 1 schematically indicates a vehicle 1, for example a passenger vehicle or a commercial vehicle, which obtains at least some of its electric drive power from a fuel cell system designated by 2. The core of said fuel cell system 2 constitutes a fuel cell 3. Said fuel cell 3 is configured as a fuel cell stack consisting of a plurality of individual cells in a manner known in the art. Only as an example, a shared anode space 4 and a shared cathode space 5 are indicated here. The fuel cell 3 is to be configured, for example, as a PEM fuel cell. Hydrogen H₂ is supplied to the fuel cell 3 from a hydrogen storage means which is not shown here, for example a pressure gas storage means. The hydrogen enters the anode space 4 of the fuel cell 3 as a fuel jet via a gas jet pump 6. Exhaust gas from the anode space 4 returns to the gas jet pump 6 via a recirculation line 7, and is taken in by the latter and fed back into the anode space 4 mixed with the fresh hydrogen. This so-called anode circuit 8 is generally known to those skilled in the art of fuel cell systems.

The anode circuit 8 may also have a water separator and/or a discharge valve 9 to discharge water and/or inert gases which accumulate in the anode circuit 8 over time from the anode circuit 8, for example from time to time or depending on the hydrogen concentration. In addition, it may include a recirculation fan as an enhancement to the gas jet pump 6, but this is not shown here similar to the water separator. Discharged gases enter an exhaust air line 11 of the fuel cell system 2 by using a line designated by 10.

Air is supplied to the cathode space 5 as an oxygen providing means via an air conveying device 12 and a gas/gas humidifier 13, which is indicated here by way of example. The exhaust air then passes through the exhaust air line 11 mentioned above, again through the gas/gas humidifier 13 into the environment. This is generally known and common practice for the one skilled in fuel cell systems. The one skilled herein also knows that other components such as charge-air-coolers, water separators, exhaust air turbines, and the like may also be provided. However, for the present invention this is of minor importance regarding the anode circuit 8, thus a detailed description thereof will be omitted.

FIG. 2 shows a cross section of the gas jet pump 6 which is schematically indicated in FIG. 1, which is referred as a jet pump. Here, a fuel gas line 14 is displayed and, in alignment hereto, an outflow line 15 configured as a Venturi tube through which the mixture of a fuel jet which is entering by the fuel gas line 14, and exhaust gas from the anode space 4 which is taken in via the recirculation line 7 flows back to the anode space 4. The particular feature of the gas jet pump 6 is a nozzle body designated by 16, which is rotatable about an axis of rotation 17, which is different from the central axis of the fuel gas line 14 and the outflow line 15 aligned hereto. A plurality of individual nozzles 18 are formed in said nozzle body 16. In the illustration of FIG. 2, a nozzle designated by 18.1 is located aligned to the fuel gas line 14 and the outflow line 15, which is provided here by way of example for an average hydrogen flow which flows to the anode space 4. The geometry thereof if configured in a way that it establishes good conditions for taking in the exhaust gas flow from the recirculation line 7 in said volume flow, in particular that a flow velocity above the speed of sound is realized, and thus the suction behavior of the gas jet pump 6 is optimized for said volume flow.

The same configuration of the gas jet pump 6 is shown again in the illustration of FIG. 3. The nozzle body 16 is correspondingly rotated about the axis of rotation 17, so that the nozzle designated by 18.1 is now arranged outside the area where the fuel gas flows, and that a nozzle designated by 18.2 for a correspondingly smaller volume flow of the dosed hydrogen has been pivoted into alignment between the fuel gas line 14 and the outflow line 15, and is now active inside the gas jet pump 6. The configuration of the nozzle body 16, which is configured as tapered in the flow direction, corresponds approximately to the drum of drum revolver, and is displayed in a top view in the illustration in FIG. 4. It may be rotated about the axis of rotation 17 accordingly, thus the nozzles 18.1-18.4, each configured with the same starting diameter matching the fuel gas line 14, process the individual volume flows in the desired manner. This means that in the exemplary embodiment shown here, four corresponding nozzles 18.1-18.4 are provided for four different orders of magnitude of volumetric flows. The configuration may be enhanced such that five, six, seven, or more individual nozzles 18 in the nozzle body 16, which is formed here in a rotationally symmetrical way, are configured, for example.

This finally results in an extraordinarily compact and efficient configuration of the gas jet pump 6, which allows a simple alignment to the dosed hydrogen flow as a fuel gas flow by pivoting the appropriate nozzle 18.1-18.4 into alignment between the fuel gas line 14 and the outflow line 15 according to the magnitude of this volume flow. This enables ideal flow conditions through the gas jet pump 6, and here in particular the part of the outflow line 15 configured as a Venturi tube, thus the best possible intake of the recirculated exhaust gas from the recirculation line 7 of the fuel cell system 2 or the anode circuit 8 is achieved by negative pressure effects and effects of impulse exchange. This is feasible without using a complex multiple piping, the use of a variety of valves and without the use of a nozzle needle.

1. An anode circuit for a fuel cell having at least one gas jet pump for recirculating anode exhaust gas, comprising at least one nozzle through which the fuel gas is able to flow as a fuel gas flow, and which comprises a fuel gas line, a recirculation line, and an outflow line,
wherein
a plurality of nozzles having different geometries are arranged in a nozzle body which is movable relative to the fuel gas line such that one of the nozzles is selectively usable, respectively.

2. (canceled)

3. (canceled)

4. The anode circuit according to claim 1,
wherein
the fuel gas line and the outflow line are configured to be aligned.

5. The anode circuit according to claim 1,
wherein
the nozzle body tapers at the outer circumference thereof in the flow direction of the fuel gas flow.

6. The anode circuit according to claim 1,
wherein
the recirculation line is formed at an angle to the fuel gas line and/or outflow line.

7. The anode circuit according to claim 6,
wherein
the angle is approximately 90°.

8. The anode circuit according to claim 1,
characterized by
its use in a fuel cell system which is to provide electric drive power in a motor vehicle.

9. The anode circuit according to claim 4,
wherein
the nozzle body tapers at the outer circumference thereof in the flow direction of the fuel gas flow.

10. The anode circuit according to claim 4,
wherein
the recirculation line is formed at an angle to the fuel gas line and/or outflow line.

11. The anode circuit according to claim 5,
wherein
the recirculation line is formed at an angle to the fuel gas line and/or outflow line.

12. The anode circuit according to claim 4,
characterized by
its use in a fuel cell system which is to provide electric drive power in a motor vehicle.

13. The anode circuit according to claim 5,
characterized by
its use in a fuel cell system which is to provide electric drive power in a motor vehicle.

14. The anode circuit according to claim 6,
characterized by
its use in a fuel cell system which is to provide electric drive power in a motor vehicle.

15. The anode circuit according to claim 7,
characterized by
its use in a fuel cell system which is to provide electric drive power in a motor vehicle.
